(19) United States
(12) Patent Application Publication
(10) Pub. No.: US 2024/0357637 A1
(43) Pub. Date: Oct. 24, 2024

(54) APPARATUS AND METHOD OF WIRELESS COMMUNICATION

(71) Applicant: GUANGDONG OPPO MOBILE TELECOMMUNICATIONS CORP., LTD., Dongguan (CN)

(72) Inventor: Hao LIN, Neuilly-sur-Seine (FR)

(21) Appl. No.: 18/761,764

(22) Filed: Jul. 2, 2024

Related U.S. Application Data
(63) Continuation of application No. PCT/IB2022/000013, filed on Jan. 7, 2022.

(51) Int. Cl. H04W 74/00; H04B 7/06; H04W 74/0816; H04W 76/20

(52) U.S. Cl. CPC H04W 74/006; H04B 7/06968; H04W 74/0816; H04W 76/20

(57) ABSTRACT

A wireless communication method by a UE includes: being configured by a base station to detect a DCI 2_0, and determining an indication information of the DCI 2_0 according to a first information.

### CROSS-REFERENCE TO RELATED APPLICATION

This application is a continuation of International Application No. PCT/IB2022/000013 filed on Jan. 7, 2022, which is incorporated herein by reference in its entirety.

### TECHNICAL FIELD

The present disclosure relates to the field of communication systems, and more particularly, to an apparatus and a method of wireless communication, which can provide a good communication performance and/or high reliability.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as long term evolution (LTE) systems, LTE-advanced (LTE-A) systems, or LTE-A pro systems, and fifth generation (5G) systems which may be referred to as new radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

In release 16 NR system, a UE can be configured to monitor a downlink control information (DCI) 2_0, which is a group common DCI format as illustrated in TS 38.213 and TS 38.212. Moving towards high frequency, e.g., frequency range 2-2 (FR2-2), an indication related to or in the DCI 2_0 needs to be improved, so that the UE can have better precision to determine the DCI 2_0 included information according to the indication.

### SUMMARY

An object of the present disclosure is to propose an apparatus (such as a user equipment (UE) and/or a base station) and a method of wireless communication.

In a first aspect of the present disclosure, a method of wireless communication by a user equipment (UE) comprises being configured by a base station to detect a downlink control information (DCI) 2_0 and determining an indication information of the DCI 2_0 according to a first information.

In some embodiments of the above method according to the first aspect of the present disclosure, the first information comprises a beam direction relevant information, and the beam direction relevant information comprises one or more beams and/or one or more beam indexes, where the one or more beam indexes correspond to one or more reference signals with indexes.

In some embodiments of any one of the above methods according to the first aspect of the present disclosure, the reference signal with index comprises a synchronization signal block (SSB) index or a channel state information reference signal (CSI-RS) resource index.

In some embodiments of any one of the above methods according to the first aspect of the present disclosure, the first information is included in the DCI 2_0 or the first information is obtained through the DCI 2_0.

In some embodiments of any one of the above methods according to the first aspect of the present disclosure, the indication information comprises a slot format indication (SFI), a channel occupancy time (COT) remaining duration, a resource block (RB) set availability, and/or a search space set group switching.

In some embodiments of any one of the above methods according to the first aspect of the present disclosure, each beam index corresponding to the reference signal with index comprises that a transmission within the COT remaining duration is quasi-co-located (QCLed) with the reference signal with index or comprises that a spatial domain filter for receiving transmissions within the COT remaining duration is same as a spatial domain filter for receiving the reference signal with index.

In some embodiments of any one of the above methods according to the first aspect of the present disclosure, the DCI 2_0 comprises N bits to indicate the beam direction relevant information for N beams, where N is an integer.

In some embodiments of any one of the above methods according to the first aspect of the present disclosure, the N bits have one to one mapping with the N beams, where the N beams is represented by N reference signal indexes.

In some embodiments of any one of the above methods according to the first aspect of the present disclosure, a first bit value of the N bits indicates that a corresponding beam is considered together with the COT remaining duration and/or the RB set availability, and/or a second bit value of the N bits indicates that another corresponding beam is not considered together with the COT remaining duration and/or the RB set availability.

In some embodiments of any one of the above methods according to the first aspect of the present disclosure, the first bit value and/or the second bit value of the N bits is a pre-defined value.

In some embodiments of any one of the above methods according to the first aspect of the present disclosure, the beam direction relevant information is used for more than one cell.

In some embodiments of any one of the above methods according to the first aspect of the present disclosure, each cell has a corresponding bit location in the DCI 2_0 for the beam direction relevant information.

In some embodiments of any one of the above methods according to the first aspect of the present disclosure, when the UE has an uplink transmission within a gNB COT, the UE shares the gNB COT for the uplink transmission.

In some embodiments of any one of the above methods according to the first aspect of the present disclosure, the UE shares the gNB COT for the uplink transmission if the UE is indicated with a scheduling request indicator (SRI) for the uplink transmission and the SRI is matched with the beam direction relevant information for the COT remaining duration and/or the RB set availability.

In some embodiments of any one of the above methods according to the first aspect of the present disclosure, the SRI matched with the beam direction relevant information comprises that a spatial domain transmission filter associated with the SRI for the uplink transmission is in a beam correspondence to or same as a spatial domain filter associated with the beam direction relevant information for the COT remaining duration and/or the RB set availability.

In some embodiments of any one of the above methods according to the first aspect of the present disclosure, the UE shares the gNB COT if the UE is indicated with a transmission configuration indicator (TCI) state for the uplink transmission and the TCI state is matched with the beam direction relevant information for the COT remaining duration and/or the RB set availability.

In some embodiments of any one of the above methods according to the first aspect of the present disclosure, the TCI state matched with the beam direction relevant information comprises that a spatial domain transmission filter associated with the TCI state for the uplink transmission is in a beam correspondence to or same as the spatial domain filter associated with the beam direction relevant information for the COT remaining duration and/or the RB set availability.

In some embodiments of any one of the above methods according to the first aspect of the present disclosure, the spatial domain filter associated with the beam direction relevant information comprises that the beam direction relevant information indicates a reference signal index, and the spatial domain filter is used to receive an indicated reference signal.

In some embodiments of any one of the above methods according to the first aspect of the present disclosure, a physical layer of the UE is configured by a higher layer of the UE to receive a downlink transmission in one or more first symbols.

In some embodiments of any one of the above methods according to the first aspect of the present disclosure, the downlink transmission comprises a physical downlink shared channel (PDSCH) transmission or a CSI-RS.

In some embodiments of any one of the above methods according to the first aspect of the present disclosure, the one or more first symbols are indicated as flexible by tdd-UL-DL-ConfigurationCommon or tdd-UL-DL-ConfigurationDedicated.

In some embodiments of any one of the above methods according to the first aspect of the present disclosure, if the beam direction relevant information for the one or more first symbols is not matched with the TCI state associated with a configured PDSCH or CSI-RS, the UE does not receive the configured PDSCH or CSI-RS in the one or more first symbols.

In some embodiments of any one of the above methods according to the first aspect of the present disclosure, the beam direction relevant information for the one or more first symbols not matched with the TCI state comprises that the spatial domain filter associated with the beam direction relevant information is not in a beam correspondence to or not same as a spatial domain filter associated with the TCI state.

In some embodiments of any one of the above methods according to the first aspect of the present disclosure, if the beam direction relevant information for the one or more first symbols is matched with the TCI state associated with the configured PDSCH or CSI-RS, and the SFI indicates the one or more first symbols as downlink, the UE receives the configured PDSCH or CSI-RS in the one or more first symbols.

In some embodiments of any one of the above methods according to the first aspect of the present disclosure, the UE is configured by the higher layer to transmit an uplink transmission in one or more second symbols.

In some embodiments of any one of the above methods according to the first aspect of the present disclosure, the uplink transmission comprises a physical uplink shared channel (PUSCH) transmission.

In some embodiments of any one of the above methods according to the first aspect of the present disclosure, the one or more second symbols are indicated as flexible by tdd-UL-DL-ConfigurationCommon or tdd-UL-DL-ConfigurationDedicated.

In some embodiments of any one of the above methods according to the first aspect of the present disclosure, if the beam direction relevant information for the one or more second symbols is not matched with the TCI state or an SRI associated with a configured PDSCH or CSI-RS, the UE does not transmit the uplink transmission in the one or more second symbols.

In some embodiments of any one of the above methods according to the first aspect of the present disclosure, the beam direction relevant information not matched with the TCI state or the SRI comprises that the spatial domain filter associated with the beam direction relevant information is not in a beam correspondence to or not same as the spatial domain filter associated with the TCI state or is not in a beam correspondence to or not same as the spatial domain filter associated with the SRI.

In some embodiments of any one of the above methods according to the first aspect of the present disclosure, if the beam direction relevant information for the one or more second symbols is matched with the TCI state or the SRI associated with the configured uplink transmission and the SFI indicates the one or more second symbols as uplink, the UE transmits the uplink transmission in the one or more second symbols.

In some embodiments of any one of the above methods according to the first aspect of the present disclosure, if the beam direction relevant information is not explicitly provided in the DCI 2_0, the UE determines the beam direction relevant information from the TCI state of a control resource set (CORESET) associated with s search space set for monitoring the DCI 2_0.

In some embodiments of any one of the above methods according to the first aspect of the present disclosure, the beam direction relevant information follows the TCI state configured or indicated for the CORESET that is associated with the search space set in which the UE detects the DCI 2_0.

In a second aspect of the present disclosure, a method of wireless communication by a base station comprises configuring to a user equipment (UE) to detect a downlink control information (DCI) 2_0 and controlling the UE to determine an indication information of the DCI 2_0 according to a first information.

In some embodiments of the above method according to the second aspect of the present disclosure, the first information comprises a beam direction relevant information, and the beam direction relevant information comprises one or more beams and/or one or more beam indexes, where the one or more beam indexes correspond to one or more reference signals with indexes.

In some embodiments of any one of the above methods according to the second aspect of the present disclosure, the reference signal with index comprises a synchronization signal block (SSB) index or a channel state information reference signal (CSI-RS) resource index.

In some embodiments of any one of the above methods according to the second aspect of the present disclosure, the first information is included in the DCI 2_0 or the first information is obtained through the DCI 2_0.

In some embodiments of any one of the above methods according to the second aspect of the present disclosure, the indication information comprises a slot format indication (SFI), a channel occupancy time (COT) remaining duration, a resource block (RB) set availability, and/or a search space set group switching.

In some embodiments of any one of the above methods according to the second aspect of the present disclosure, each beam index corresponding to the reference signal with index comprises that a transmission within the COT remaining duration is quasi-co-located (QCLed) with the reference signal with index or comprises that a spatial domain filter for receiving transmissions within the COT remaining duration is same as a spatial domain filter for receiving the reference signal with index.

In some embodiments of any one of the above methods according to the second aspect of the present disclosure, the DCI 2_0 comprises N bits to indicate the beam direction relevant information for N beams, where N is an integer.

In some embodiments of any one of the above methods according to the second aspect of the present disclosure, the N bits have one to one mapping with the N beams, where the N beams is represented by N reference signal indexes.

In some embodiments of any one of the above methods according to the second aspect of the present disclosure, a first bit value of the N bits indicates that a corresponding beam is considered together with the COT remaining duration and/or the RB set availability, and/or a second bit value of the N bits indicates that another corresponding beam is not considered together with the COT remaining duration and/or the RB set availability.

In some embodiments of any one of the above methods according to the second aspect of the present disclosure, the first bit value and/or the second bit value of the N bits is a pre-defined value.

In some embodiments of any one of the above methods according to the second aspect of the present disclosure, the beam direction relevant information is used for more than one cell.

In some embodiments of any one of the above methods according to the second aspect of the present disclosure, each cell has a corresponding bit location in the DCI 2_0 for the beam direction relevant information.

In some embodiments of any one of the above methods according to the second aspect of the present disclosure, when the UE has an uplink transmission within a gNB COT, the UE shares the gNB COT for the uplink transmission.

In some embodiments of any one of the above methods according to the second aspect of the present disclosure, the UE shares the gNB COT for the uplink transmission if the UE is indicated with a scheduling request indicator (SRI) for the uplink transmission and the SRI is matched with the beam direction relevant information for the COT remaining duration and/or the RB set availability.

In some embodiments of any one of the above methods according to the second aspect of the present disclosure, the SRI matched with the beam direction relevant information comprises that a spatial domain transmission filter associated with the SRI for the uplink transmission is in a beam correspondence to or same as a spatial domain filter associated with the beam direction relevant information for the COT remaining duration and/or the RB set availability.

In some embodiments of any one of the above methods according to the second aspect of the present disclosure, the UE shares the gNB COT if the UE is indicated with a transmission configuration indicator (TCI) state for the uplink transmission and the TCI state is matched with the beam direction relevant information for the COT remaining duration and/or the RB set availability.

In some embodiments of any one of the above methods according to the second aspect of the present disclosure, the TCI state matched with the beam direction relevant information comprises that a spatial domain transmission filter associated with the TCI state for the uplink transmission is in a beam correspondence to or same as the spatial domain filter associated with the beam direction relevant information for the COT remaining duration and/or the RB set availability.

In some embodiments of any one of the above methods according to the second aspect of the present disclosure, the spatial domain filter associated with the beam direction relevant information comprises that the beam direction relevant information indicates a reference signal index, and the spatial domain filter is used to receive an indicated reference signal.

In some embodiments of any one of the above methods according to the second aspect of the present disclosure, a physical layer of the UE is configured by a higher layer of the UE to receive a downlink transmission in one or more first symbols.

In some embodiments of any one of the above methods according to the second aspect of the present disclosure, the downlink transmission comprises a physical downlink shared channel (PDSCH) transmission or a CSI-RS.

In some embodiments of any one of the above methods according to the second aspect of the present disclosure, the one or more first symbols are indicated as flexible by tdd-UL-DL-ConfigurationCommon or tdd-UL-DL-ConfigurationDedicated.

In some embodiments of any one of the above methods according to the second aspect of the present disclosure, if the beam direction relevant information for the one or more first symbols is not matched with the TCI state associated with a configured PDSCH or CSI-RS, the UE does not receive the configured PDSCH or CSI-RS in the one or more first symbols.

In some embodiments of any one of the above methods according to the second aspect of the present disclosure, the beam direction relevant information for the one or more first symbols not matched with the TCI state comprises that the spatial domain filter associated with the beam direction relevant information is not in a beam correspondence to or not same as a spatial domain filter associated with the TCI state.

In some embodiments of any one of the above methods according to the second aspect of the present disclosure, if the beam direction relevant information for the one or more first symbols is matched with the TCI state associated with the configured PDSCH or CSI-RS, and the SFI indicates the one or more first symbols as downlink, the UE receives the configured PDSCH or CSI-RS in the one or more first symbols.

In some embodiments of any one of the above methods according to the second aspect of the present disclosure, the UE is configured by the higher layer to transmit an uplink transmission in one or more second symbols.

In some embodiments of any one of the above methods according to the second aspect of the present disclosure, the uplink transmission comprises a physical uplink shared channel (PUSCH) transmission.

In some embodiments of any one of the above methods according to the second aspect of the present disclosure, the one or more second symbols are indicated as flexible by tdd-UL-DL-ConfigurationCommon or tdd-UL-DL-ConfigurationDedicated.

In some embodiments of any one of the above methods according to the second aspect of the present disclosure, if the beam direction relevant information for the one or more second symbols is not matched with the TCI state or an SRI associated with a configured PDSCH or CSI-RS, the UE does not transmit the uplink transmission in the one or more second symbols.

In some embodiments of any one of the above methods according to the second aspect of the present disclosure, the beam direction relevant information not matched with the TCI state or the SRI comprises that the spatial domain filter associated with the beam direction relevant information is not in a beam correspondence to or not same as the spatial domain filter associated with the TCI state or is not in a beam correspondence to or not same as the spatial domain filter associated with the SRI.

In some embodiments of any one of the above methods according to the second aspect of the present disclosure, if the beam direction relevant information for the one or more second symbols is matched with the TCI state or the SRI associated with the configured uplink transmission and the SFI indicates the one or more second symbols as uplink, the UE transmits the uplink transmission in the one or more second symbols.

In some embodiments of any one of the above methods according to the second aspect of the present disclosure, if the beam direction relevant information is not explicitly provided in the DCI 2_0, the UE determines the beam direction relevant information from the TCI state of a control resource set (CORESET) associated with s search space set for monitoring the DCI 2_0.

In some embodiments of any one of the above methods according to the second aspect of the present disclosure, the beam direction relevant information follows the TCI state configured or indicated for the CORESET that is associated with the search space set in which the UE detects the DCI 2_0.

In a third aspect of the present disclosure, a user equipment comprises a memory, a transceiver, and a processor coupled to the memory and the transceiver. The processor is configured to perform the above method.

In a fourth aspect of the present disclosure, a base station comprises a memory, a transceiver, and a processor coupled to the memory and the transceiver. The processor is configured to perform the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a non-transitory computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station (e.g., gNB or eNB) of communication in a communication network system (e.g., non-terrestrial network (NTN) or a terrestrial network) according to an embodiment of the present disclosure.

FIG. 2 is a flowchart illustrating a method of wireless communication performed by a user equipment (UE) according to an embodiment of the present disclosure.

FIG. 3 is a flowchart illustrating a method of wireless communication performed by a base station according to an embodiment of the present disclosure.

FIG. 4 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In release 16 new radio (NR) system, a user equipment (UE) can be configured to monitor a downlink control information (DCI) 2_0, which is a group common DCI format as illustrated in TS 38.213 and TS 38.212. The DCI 2_0 may be configured to contain the following information: 1) SFI indication, 2) COT remaining duration, 3) RB set availability, and/or 4) search space set group (SSSG) switching. One of useful features for SFI is that the SFI indication is used to cancel pre-configured transmissions. The COT remaining duration indication and the RB set availability indication tell UE whether a gNB has access a channel and a remaining duration for the gNB to further occupy the channel. Further, an SSSG switching flag informs the UE to switch from one SSSG to another SSSG.

In high frequency band, e.g., FR2-2, beam forming is a necessary technique for attending a reliable communication. Thus, beam level indication becomes an important information for the UE to better understand beam directions together with information provided by the DCI 2_0. In this disclosure, some embodiments present a method for a gNB providing such beam level information to a UE. Moreover, some embodiments present a method for the UE to determine DCI 2_0 included information with better precision.

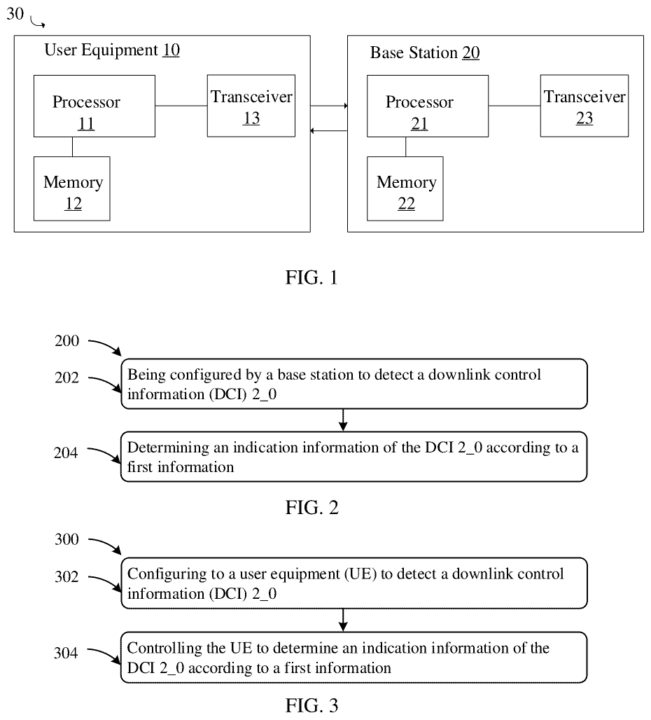

FIG. 1 illustrates that, in some embodiments, one or more user equipments (UEs) 10 and a base station (e.g., gNB or eNB) 20 for transmission adjustment in a communication network system 30 (e.g., non-terrestrial network (NTN) or terrestrial network) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured by the base station 20 to detect a downlink control information (DCI) 2_0, and the processor 11 is configured to determine an indication information of the DCI 2_0 according to a first information. This can provide a method for the UE 10 to determine a downlink control information (DCI) 2_0 included information with better precision, provide a good communication performance, and/or provide high reliability.

In some embodiments, the processor 21 configures the UE 10 to detect a downlink control information (DCI) 2_0, and the processor 21 controls the UE 10 to determine an indication information of the DCI 2_0 according to a first information. This can provide a method for the UE to determine a downlink control information (DCI) 2_0 included information with better precision, provide a good communication performance, and/or provide high reliability.

FIG. 2 illustrates a method 200 of wireless communication by a user equipment (UE) according to an embodiment of the present disclosure. In some embodiments, the method 200 includes: a block 202, being configured by a base station to detect a downlink control information (DCI) 2_0, and a block 204, determining an indication information of the DCI 2_0 according to a first information. This can provide a method for the UE to determine a downlink control information (DCI) 2_0 included information with better precision, provide a good communication performance, and/or provide high reliability.

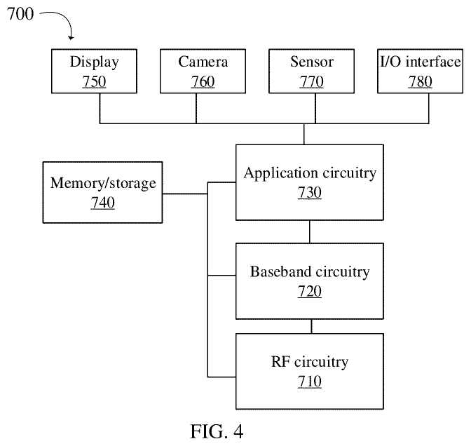

FIG. 3 illustrates a method 300 of wireless communication by a base station according to an embodiment of the present disclosure. In some embodiments, the method 300 includes: a block 302, configuring to a user equipment (UE) to detect a downlink control information (DCI) 2_0, and a block 304, controlling the UE to determine an indication information of the DCI 2_0 according to a first information. This can provide a method for the UE to determine a downlink control information (DCI) 2_0 included information with better precision, provide a good communication performance, and/or provide high reliability.

In some embodiments, the first information comprises a beam direction relevant information, and the beam direction relevant information comprises one or more beams and/or one or more beam indexes, where the one or more beam indexes correspond to one or more reference signals with indexes. In some embodiments, the reference signal with index comprises a synchronization signal block (SSB) index or a channel state information reference signal (CSI-RS) resource index. In some embodiments, the first information is included in the DCI 2_0 or the first information is obtained through the DCI 2_0. In some embodiments, the indication information comprises a slot format indication (SFI), a channel occupancy time (COT) remaining duration, a resource block (RB) set availability, and/or a search space set group switching. In some embodiments, each beam index corresponding to the reference signal with index comprises that a transmission within the COT remaining duration is quasi-co-located (QCLed) with the reference signal with index or comprises that a spatial domain filter for receiving transmissions within the COT remaining duration is same as a spatial domain filter for receiving the reference signal with index.

In some embodiments, the DCI 2_0 comprises N bits to indicate the beam direction relevant information for N beams, where N is an integer. In some embodiments, the N bits have one to one mapping with the N beams, where the N beams is represented by N reference signal indexes. In some embodiments, a first bit value of the N bits indicates that a corresponding beam is considered together with the COT remaining duration and/or the RB set availability, and/or a second bit value of the N bits indicates that another corresponding beam is not considered together with the COT remaining duration and/or the RB set availability. In some embodiments, the first bit value and/or the second bit value of the N bits is a pre-defined value. In some embodiments, the beam direction relevant information is used for more than one cell. In some embodiments, each cell has a corresponding bit location in the DCI 2_0 for the beam direction relevant information.

In some embodiments, when the UE has an uplink transmission within a gNB COT, the UE shares the gNB COT for the uplink transmission. In some embodiments, the UE shares the gNB COT for the uplink transmission if the UE is indicated with a scheduling request indicator (SRI) for the uplink transmission and the SRI is matched with the beam direction relevant information for the COT remaining duration and/or the RB set availability. In some embodiments, the SRI matched with the beam direction relevant information comprises that a spatial domain transmission filter associated with the SRI for the uplink transmission is in a beam correspondence to or same as a spatial domain filter associated with the beam direction relevant information for the COT remaining duration and/or the RB set availability. In some embodiments, the UE shares the gNB COT if the UE is indicated with a transmission configuration indicator (TCI) state for the uplink transmission and the TCI state is matched with the beam direction relevant information for the COT remaining duration and/or the RB set availability.

In some embodiments, the TCI state matched with the beam direction relevant information comprises that a spatial domain transmission filter associated with the TCI state for the uplink transmission is in a beam correspondence to or same as the spatial domain filter associated with the beam direction relevant information for the COT remaining duration and/or the RB set availability. In some embodiments, the spatial domain filter associated with the beam direction relevant information comprises that the beam direction relevant information indicates a reference signal index, and the spatial domain filter is used to receive an indicated reference signal. In some embodiments, a physical layer of the UE is configured by a higher layer of the UE to receive a downlink transmission in one or more first symbols. In some embodiments, the downlink transmission comprises a physical downlink shared channel (PDSCH) transmission or a CSI-RS. In some embodiments, the one or more first symbols are indicated as flexible by tdd-UL-DL-ConfigurationCommon or tdd-UL-DL-ConfigurationDedicated.

In some embodiments, if the beam direction relevant information for the one or more first symbols is not matched with the TCI state associated with a configured PDSCH or CSI-RS, the UE does not receive the configured PDSCH or CSI-RS in the one or more first symbols. In some embodiments, the beam direction relevant information for the one or more first symbols not matched with the TCI state comprises that the spatial domain filter associated with the beam direction relevant information is not in a beam correspondence to or not same as a spatial domain filter associated with the TCI state. In some embodiments, if the beam direction relevant information for the one or more first symbols is matched with the TCI state associated with the configured PDSCH or CSI-RS, and the SFI indicates the one or more first symbols as downlink, the UE receives the configured PDSCH or CSI-RS in the one or more first symbols. In some embodiments, the UE is configured by the higher layer to transmit an uplink transmission in one or more second symbols. In some embodiments, the uplink transmission comprises a physical uplink shared channel (PUSCH) transmission. In some embodiments, the one or more second symbols are indicated as flexible by tdd-UL-DL-ConfigurationCommon or tdd-UL-DL-ConfigurationDedicated.

In some embodiments, if the beam direction relevant information for the one or more second symbols is not matched with the TCI state or an SRI associated with a configured PDSCH or CSI-RS, the UE does not transmit the uplink transmission in the one or more second symbols. In some embodiments, the beam direction relevant information not matched with the TCI state or the SRI comprises that the spatial domain filter associated with the beam direction relevant information is not in a beam correspondence to or not same as the spatial domain filter associated with the TCI state or is not in a beam correspondence to or not same as the spatial domain filter associated with the SRI. In some embodiments, if the beam direction relevant information for the one or more second symbols is matched with the TCI state or the SRI associated with the configured uplink transmission and the SFI indicates the one or more second symbols as uplink, the UE transmits the uplink transmission in the one or more second symbols. In some embodiments, if the beam direction relevant information is not explicitly provided in the DCI 2_0, the UE determines the beam direction relevant information from the TCI state of a control resource set (CORESET) associated with s search space set for monitoring the DCI 2_0. In some embodiments, the beam direction relevant information follows the TCI state configured or indicated for the CORESET that is associated with the search space set in which the UE detects the DCI 2_0.

The examples given in this disclosure can be applied for IoT device or NB-IoT UE in NTN systems, but the method is not exclusively restricted to NTN system nor for IoT devices or NB-IoT UE. The examples given in this disclosure can be applied for NR systems, LTE systems, or NB-IoT systems. Further, some examples in the present disclosure can be applied for NB-IoT system, the PDCCH is equivalent to NB-PDCCH (NPDCCH) and the PDSCH is equivalent to NB-PDSCH (NPDSCH).

### Example

In some examples, a gNB configures a UE to monitor DCI 2_0, and the DCI 2_0 contains a COT remaining duration and/or RB set availability indication and a beam direction relevant information. The COT remaining duration and/or the RB set availability is determined together with the beam direction relevant information. In some examples, when combine the COT remaining duration and the beam direction relevant information, it represents a gNB remaining duration for a given beam direction, where a beam direction is provided by the beam direction relevant information. In some examples, the DCI 2_0 contains indication for one or more beam indexes, where each beam index corresponds to a reference signal with index, e.g., SSB index or CSI-RS resource index. In this example, a beam index corresponding to a reference signal may also mean that the transmission within the COT remaining duration may be QCLed with the reference signal with index. In some examples, the DCI 2_0 contains N bits to indicate the beam direction information for N beams, where N is an integer. The N bits may have one to one mapping with N beams, where N beams may be represented by N reference signal indexes, e.g., SSB index or CSI-RS resource index. When the bit value is “1”, it may indicate the corresponding beam should be considered together with the COT remaining duration and/or the RB set availability indication as explained in the above examples.

An example is given in the following: the gNB has configured a first beam (B1) and a second beam (B2), thus in the DCI 2_0, there are 2 bits used for beam level indication. Moreover, the DCI 2_0 is further configured to contain COT remaining duration and/or RB set availability indication. When a UE receives the DCI 2_0 and the interpretation of the COT remaining duration and/or the RB set availability is as follows: if the 2 bit beam level indication has value ‘10’, it means that the COT remaining duration and/or the RB set availability is valid for the first beam direction but not for the second beam direction. On the other hand, when the beam level indication has value ‘11’, it means that the COT remaining duration and/or the RB set availability indication is valid for the first and the second beam direction. In this example, we assume that if the bit value is “1”, the corresponding beam is the beam direction applied for the COT remaining duration and/or the RB set availability. It is to note that, this bit value is a pre-defined value which may be “1” or “0”. In some examples, the DCI 2_0 includes the bean level indication for more than one cell. Each cell has its corresponding bit location in the DCI 2_0 for beam level indication.

In some examples, the beam level indication in DCI 2_0 may be used together with SFI indication. In some examples, when a UE has an uplink transmission within a gNB COT, e.g., the time and frequency resources for the uplink transmission are within the gNB COT remaining duration in time domain and within available RB set in frequency domain, the UE may share the gNB COT for transmitting the uplink, such as the UE may use a different type of channel access procedure from the originally configured one, when performing the COT sharing. The COT sharing satisfies the following condition, which is relevant to the beam level indication. The UE may share gNB COT if the UE is indicated with an SRI for the uplink transmission and the SRI is matched with the beam level indication for the COT remaining duration and/or the RB set availability. Here the SRI matched with the beam level indication means that the spatial domain transmission filter associated with the indicated SRI for the uplink transmission is in beam correspondence to (or in the same as) the spatial domain filter associated with the beam level indication for the COT remaining duration and/or the RB set availability. The spatial domain filter associated with the beam level indication means that the beam level indication may indicates a reference signal index, and the spatial domain filter is used to receive the indicated reference signal.

In some examples, the UE may share gNB COT if the UE is indicated with a TCI state for the uplink transmission and the indicated TCI state is matched with the beam level indication for the COT remaining duration and/or the RB set availability. Here the TCI state matched with the beam level indication means that the spatial domain transmission filter associated with the indicated TCI state for the uplink transmission is same as the spatial domain filter associated with the beam level indication for the COT remaining duration and/or the RB set availability. The spatial domain filter associated with the beam level indication means that the beam level indication may indicates a reference signal index, and the spatial domain filter is used to receive the indicated reference signal.

In some examples, the UE is configured by higher layer to receive downlink transmission, e.g., PDSCH or CSI-RS in one or more symbols and the one or more symbols are indicated as flexible by tdd-UL-DL-ConfigurationCommon, or tdd-UL-DL-ConfigurationDedicated. The UE may receive a DCI 2_0, and the DCI 2_0 contains beam level indication for SFI. If the beam level indication for the one or more symbols is not matched with the TCI state associated with the configured PDSCH or CSI-RS, the UE does not receive the configured PDSCH or CSI-RS in the one or more symbols. In this example, the beam level indication not matched with TCI state means that the spatial domain filter associated with the beam level indication is not same as the spatial domain filter associated with the TCI state. In some examples, if the beam level indication for the one or more symbols is matched with the TCI state associated with the configured PDSCH or CSI-RS, and the SFI indicates the one or more symbols as downlink, the UE receives the configured PDSCH or CSI-RS in the one or more symbols.

In some examples, the UE is configured by higher layer to transmit uplink transmission, e.g., PUSCH in one or more symbols and the one or more symbols are indicated as flexible by tdd-UL-DL-ConfigurationCommon, or tdd-UL-DL-ConfigurationDedicated. The UE may receive a DCI 2_0, and the DCI 2_0 contains beam level indication for SFI. If the beam level indication for the one or more symbols is not matched with the TCI state or SRI associated with the configured PDSCH or CSI-RS, the UE does not transmit the uplink transmission in the one or more symbols. In this example, the beam level indication not matched with TCI state or SRI means that the spatial domain filter associated with the beam level indication is not same as the spatial domain filter associated with the TCI state or is not in correspondence to the spatial domain filter associated with the SRI. In some examples, if the beam level indication for the one or more symbols is matched with the TCI state or the SRI associated with the configured uplink transmission, and the SFI indicates the one or more symbols as uplink, the UE may transmit the uplink in the one or more symbols.

In some examples, the beam level indication is not explicitly provided in the DCI 2_0, the UE may determine the beam level indication from the TCI state of the CORESET associated with the search space set for monitoring DCI 2_0. For example, when the UE detects a DCI 2_0, the beam level indication follows the TCI state configured or indicated for the CORESET that is associated with the search space set in which UE detects the DCI 2_0.

Commercial interests for some embodiments are as follows. 1. Providing a method for the UE to determine a downlink control information (DCI) 2_0 included information with better precision. 2. Improving power consumption. 3. Providing a good communication performance. 4. Providing a high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in 5G NR licensed and non-licensed or shared spectrum communications. Some embodiments of the present disclosure propose technical mechanisms.

FIG. 4 is a block diagram of an example system 700 for wireless communication according to an embodiment of the present disclosure. Embodiments described herein may be implemented into the system using any suitably configured hardware and/or software. FIG. 4 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with some embodiments, it is understood that the present disclosure is not limited to the disclosed embodiments but is intended to cover various arrangements made without departing from the scope of the broadest interpretation of the appended claims.

What is claimed is:

1. A wireless communication method by a user equipment (UE), comprising:
being configured by a base station to detect a downlink control information (DCI) 2_0; and
determining an indication information of the DCI 2_0 according to a first information.

2. The method of claim 1, wherein the first information comprises a beam direction relevant information, and the beam direction relevant information comprises one or more beams and/or one or more beam indexes, where the one or more beam indexes correspond to one or more reference signals with indexes.

3. The method of claim 1, wherein the first information is included in the DCI 2_0 or the first information is obtained through the DCI 2_0.

4. The method of claim 1, wherein the indication information comprises a slot format indication (SFI), a channel occupancy time (COT) remaining duration, a resource block (RB) set availability, and/or a search space set group switching.

5. The method of claim 4, wherein each beam index corresponding to the reference signal with index comprises that a transmission within the COT remaining duration is quasi-co-located (QCLed) with the reference signal with index or comprises that a spatial domain filter for receiving transmissions within the COT remaining duration is same as a spatial domain filter for receiving the reference signal with index.

6. The method of claim 2, wherein the DCI 2_0 comprises N bits to indicate the beam direction relevant information for N beams, where Nis an integer.

7. The method of claim 6, wherein the N bits have one to one mapping with the N beams, where the N beams is represented by N reference signal indexes.

8. The method of claim 7, wherein a first bit value of the N bits indicates that a corresponding beam is considered together with the COT remaining duration and/or the RB set availability, and/or a second bit value of the N bits indicates that another corresponding beam is not considered together with the COT remaining duration and/or the RB set availability.

9. The method of claim 2, wherein the beam direction relevant information is used for more than one cell.

10. The method of claim 1, wherein when the UE has an uplink transmission within a gNB COT, the UE shares the gNB COT for the uplink transmission.

11. The method of claim 10, wherein the UE shares the gNB COT for the uplink transmission if the UE is indicated with a scheduling request indicator (SRI) for the uplink transmission and the SRI is matched with the beam direction relevant information for the COT remaining duration and/or the RB set availability.

12. The method of claim 10, wherein the UE shares the gNB COT if the UE is indicated with a transmission configuration indicator (TCI) state for the uplink transmission and the TCI state is matched with the beam direction relevant information for the COT remaining duration and/or the RB set availability.

13. The method of claim 1, wherein a physical layer of the UE is configured by a higher layer of the UE to receive a downlink transmission in one or more first symbols.

14. The method of claim 1, wherein if the beam direction relevant information is not explicitly provided in the DCI 2_0, the UE determines the beam direction relevant information from the TCI state of a control resource set (CORESET) associated with s search space set for monitoring the DCI 2_0.

15. A wireless communication method by a base station, comprising:
configuring a user equipment (UE) to detect a downlink control information (DCI) 2_0; and
controlling the UE to determine an indication information of the DCI 2_0 according to a first information.

16. A user equipment (UE), comprising:
a memory;
a transceiver; and
a processor coupled to the memory and the transceiver;
wherein the processor is configured to perform:
being configured by a base station to detect a downlink control information (DCI) 2_0; and
determining an indication information of the DCI 2_0 according to a first information.

17. The UE of claim 16, wherein the first information comprises a beam direction relevant information, and the beam direction relevant information comprises one or more beams and/or one or more beam indexes, where the one or more beam indexes correspond to one or more reference signals with indexes;
or
the first information is included in the DCI 2_0 or the first information is obtained through the DCI 2_0.

18. A base station, comprising:
a memory;
a transceiver; and
a processor coupled to the memory and the transceiver;
wherein the processor is configured to perform the method of claim 15.

19. A chip, comprising:
a processor, configured to call and run a computer program stored in a memory, to cause a device in which the chip is installed to execute the method of claim 1.

20. A chip, comprising:
a processor, configured to call and run a computer program stored in a memory, to cause a device in which the chip is installed to execute the method of claim 15.
